(19) United States
(12) Patent Application Publication
(10) Pub. No.: US 2010/0250317 A1
(43) Pub. Date: Sep. 30, 2010

(54) Resource Modeling Tool

(75) Inventors: Catharine P. Train, Norfolk, VA (US); Theresa M. Jones, Charlotte, NC (US); Charles C. Reiney, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 12/412,426

(22) Filed: Mar. 27, 2009

(51) Int. Cl. G06Q 10/00

(52) U.S. Cl. 705/8

(57) ABSTRACT

A method and apparatus for allowing a user to model the level of resources required by resource type to support a specific funding level. The model is based on a plurality of factors such as resource rates per hour, amount of resources burned monthly, and the current level of resource staffing. The model allows a user to quickly view “what if” funding scenarios and may further be utilized to determine the level of funding that can be effectively utilized by anticipating the number of resources needed to support the funding level.

### FIELD OF THE INVENTION

Aspects of the disclosure relate to a resource modeling tool. More specifically, aspects of the invention relate to modeling the level of resources supported by funding level.

### BACKGROUND

Budgeting resources is imperative to the success of any business. That said, small companies may find that a personnel budget may be easily developed and tracked since there may be only a few workers. In such a situation, the ability to gain an overall picture of the entire pool of resources might not be difficult. However, for large corporations with thousands of employees and contractors, with a number of different salaries and different roles on one or more different projects, keeping track of the overall financial picture becomes more difficult.

Efficient management of a business's financial budget requires a comprehensive understanding of the budget along with the amount and type of worker (e.g., employee, contractor, etc.) whose efforts may be required to complete projects and other tasks on time to enable a company to thrive.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Resource types as used in this application may include but are not limited to employees, associates, part-time contractors, full-time contractors, and the like. Portfolio as used herein may include any desired grouping of projects or tasks by a particular business. Service providers as used herein may include any number of teams, departments, and lines of businesses that are tasked to complete the projects within the portfolios. One portfolio may span several service providers and one service provider may be tasked to complete a portion or the entirety of one or more portfolios. Each resource, regardless of resource type, may be assigned to be part of one or more service providers handling one or more different portfolios. As used herein, the terms “funding level,” “funding pool,” and “budget” are interchangeable and refer to the amount of funds available and/or allocated.

The resource modeling tool may be used to generate models which visually illustrate the number and types of different resources which may be supported by a particular funding level given a particular burn rate. For example, the model may take actual funding levels and/or predicted future funding levels to determine how many more or less of each type of resource may be supported by the funding level.

In one aspect, the model may further take into account an actual or predicted burn rate to normalize the funding level (which may be annual) to the desired scope (which may be monthly). For example, the model may multiply an annual funding level by a monthly burn rate to determine the portion of the annual pool that may be allocated to the particular month.

In another aspect, the model may be efficiently regenerated with one or more different variables such that a user may visually gain an understanding of the impact of the change in variables.

The methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present disclosure is illustrated by way of example and not limited in the accompanying figures in which like reference numerals indicate similar elements.

FIG. 1 illustrates an example operating environment in which various aspects of the disclosure may be used.

FIG. 2 illustrates an example environment in which a method of resource modeling may be used in accordance with one or more illustrative aspects described herein.

FIG. 3A is a flowchart illustrating an example method of modeling a level of resources required by resource type to support a specific funding level in accordance with one or more aspects described herein.

FIG. 3B is a flowchart illustrating an example method of updating an existing model by changing one or more variables in accordance with one or more aspects described herein.

FIG. 4 is a flowchart illustrating an example method of calculating a future staffing breakdown in accordance with one or more aspects described herein.

FIG. 5 illustrates an example of a display of a resulting model in accordance with one or more aspects described herein.

FIG. 6 illustrates an example of an interface in accordance with one or more aspects described herein.

### DETAILED DESCRIPTION

In accordance with various aspects of the disclosure, systems and methods are illustrated for providing resource modeling. A business may determine whether to add, subtract, or maintain a current workforce based at least in part on the system, and method described below in various aspects.

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

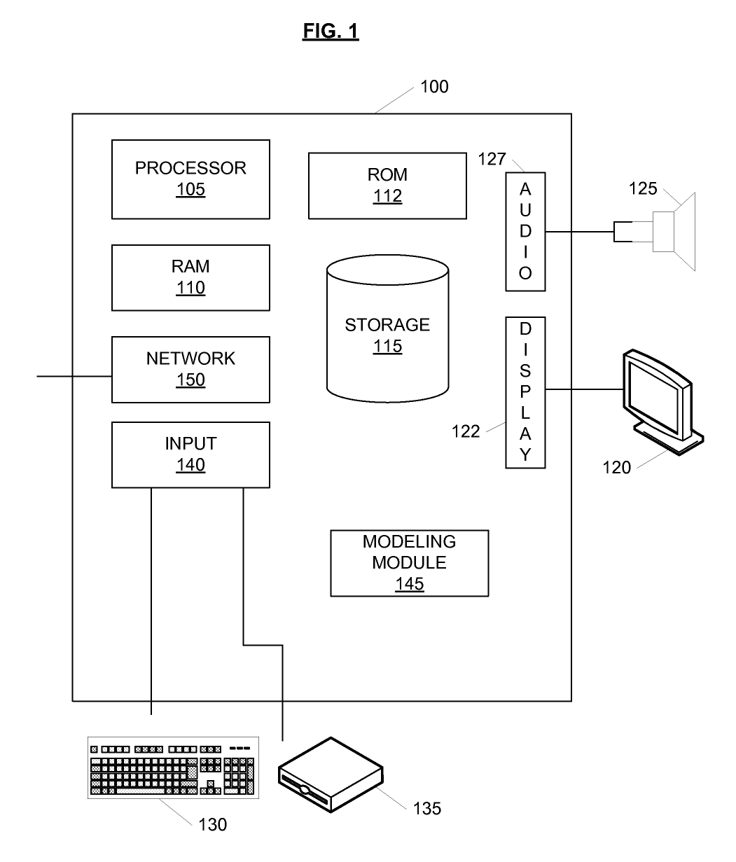

FIG. 1 illustrates a computing environment in which one or more aspects described herein may be implemented. A computing device such as computer 100 may house a variety of components for inputting, outputting, storing and processing data. Computer 100 may include desktop computers, laptop computers, ultra mobile PCs, handheld scanners and the like. Processor 105 may perform a variety of tasks including executing one or more applications, retrieving data from a storage device such as storage 115 and/or outputting data to a device such as display 120. Processor 105 may also communicate with modeling module 145 to perform aspects described herein. In one alternative, modeling module may be a software module configured to perform the aspects described herein. Processor 105 may be connected to Random Access Memory (RAM) module 110 in which application data and/or instructions may be temporarily stored. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the processor 105 is executing the application.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or a universal serial bus (USB) connection (not shown). As with output devices 120 and 125, each of the input devices 130 and 135 may be associated with an adapter 140 for converting the input into computer readable/recognizable data. In one example, data received through USB (not shown) may be stored in a data file.

Computer 100 may further include one or more communication components for receiving and transmitting data over a network. Various types of networks include cellular networks, digital broadcast networks, Internet Protocol (IP) networks and the like. Computer 100 may include adapters suited to communicate through one or more of these networks. In particular, computer 100 may include network adapter 150 for communication with one or more other computer or computing devices over an IP network. In one example, adapter 150 may facilitate transmission of data such as configuration data or other data related to the sending device. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instructions associated with processing cellular network packets. In one or more arrangements, network adapter 150 may provide wireless network access for computer 100.

One of skill in the art will appreciate that computing devices such as computer 100 may include a variety of other components and is not limited to the devices and systems described in FIG. 1.

The resource modeling tool may function to allow a user to model the resource details, such as the number of associates and the number of contractors which may be supported given a particular funding pool. The modeling tool may receive inputs from a keyboard or other input device or may receive input from another computer server, or any other computing device. The modeling tool may generate a model displayed on a display such as a computer monitor, television, or any other screen. Alternatively, the tool may send display data to another computing device for display. The model generated by the modeling tool may be utilized to visually ascertain a mix of resource types, a total number of resource types, and may further be used to determine if a particular mix of resource types sustainable by a particular funding pool may be sufficient to accomplish the tasks within a portfolio.

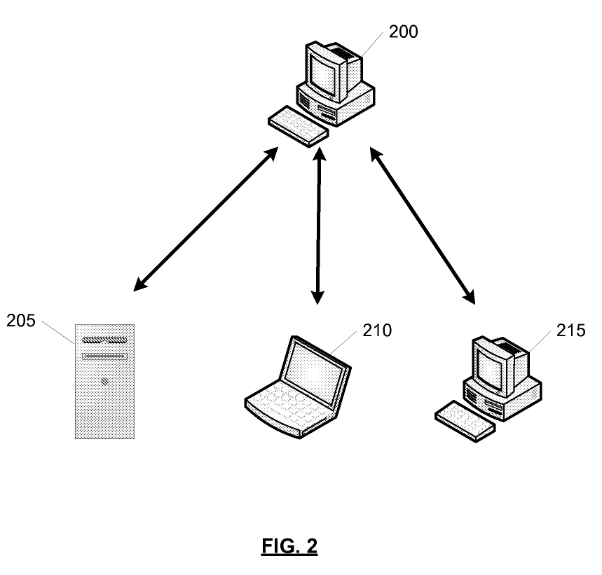

FIG. 2 illustrates one configuration of an environment in which a method of resource modeling may be performed in accordance with one or more illustrative aspects described herein. Networked computer 200, which may be a computing device 100 (FIG. 1), may send a request to each target device 205, 210 and 215 information such as data stored in a database. Other target devices (not shown) may include other computers, laptops, servers, mobile communication devices, and the like. Computer 200 may also be configured to receive a response to the request. The transmission of the request from computer 200 to the target device 205, 210 and 215 and the transmission of the response to the request from each target device 205, 210 and 215 to computer 200 may be performed over a closed network, the internet, or a direct connection (e.g. via a USB cable connecting the two devices or via BLUETOOTH). In one configuration, target devices may include a server storing historical data related to financial information. Computer 200 may be configured to generate the model based on the information received from other devices. Alternatively, the model may be generated at another device and sent to computer 200 for display.

Moreover, the modeling tool may display different models based on a selected vantage point and scope. The vantage point may, for example, be a selection of several portfolios or may be a selection of several service providers servicing portfolios. For instance, the user may select to view a model by certain selected portfolios and may limit the scope to be a 3-year span. Alternatively, the user may select to view the model by selected lines of business and may choose a 6-month span to be the scope of the model. By setting the variables to be included in the modeling and by selecting the vantage point, the user may be able to generate a plurality of different scenarios where each scenario is a model based on the particular variables and vantage point selected.

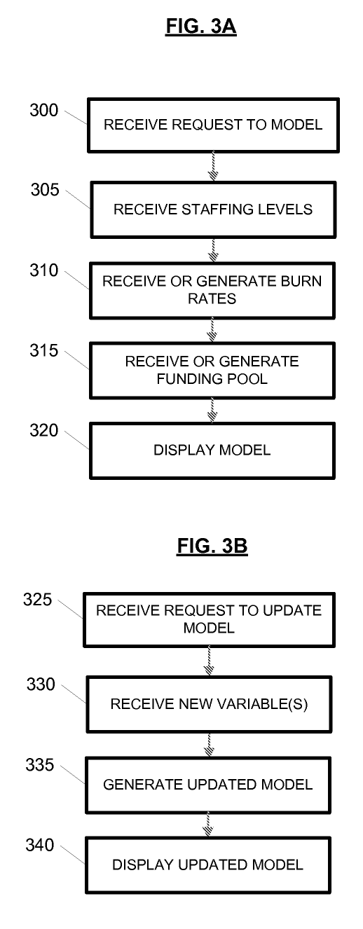

FIG. 3A is a flowchart illustrating a method of modeling a level of resources required by resource type to support a specific funding level in accordance with one or more aspects described herein. At step 300, a modeling module, e.g., processor 105 of computer 100 (or in one alternative, module 145 under the control of processor 105) may receive a request to model or visually chart a demand by resource type for a specific time period. The period of time may be set as desired, for example, 6 months or a year and may include a portion of time that has already occurred and a portion of time that has not yet occurred. For example, the scope of the request may be for the period of January 2009-June 2009 in monthly increments. For a current calendar date of Mar. 1, 2009, the span of time between January 2009 and February 2009 may be deemed in the past as it has already occurred, and as such, actual statistics may be available for this period. For the duration of time that has not yet occurred (e.g., March 2009-June 2009) the model may forecast or predict these statistics based on any number of variables. In one aspect, the user may specify a period of time including a begin date and end date which occur both in the future.

At step 305, the module may retrieve actual staffing levels for past months within the scope of the model and may take desired staffing levels as an input for the future months within the scope of the model. The actual levels are based upon realized statistics and may be, in one example, actual staffing levels as of the first date of each month included in the scope of the particular model.

At step 310, the module may retrieve actual burn rates corresponding to the time frame of the actual staffing level statistics and may generate or receive as an input the desired burn rates for future months. A burn rate may be a calculation of the percentage of the annual funding pool that is allotted or exhausted during the particular time frame. Since an annual budget might not be exhausted at a uniform rate throughout the year, (e.g., 10% of the budget may be used the first half of the year and the remaining 40% of the budget may be used in the second half of the year), the monthly burn rate is a variable that may be used to more accurately determine how much of the annual funding pool should be allotted to the particular month. For example, a uniform monthly burn distribution would result in 8.33% of the annual pool being allocated to each month of that year (given that 100% of funds are used over one year). Here, actual burn rates may be used to predict forecasted burn rates. Historical data collected over a span of time may suggest, for example, that a particular business (e.g., a lawn-mowing business) is busiest during the summer months of May, June, and July when grass is grows the fastest, and accordingly, 50% of the annual budget is utilized during these three months to hire extra seasonal workers. Accordingly, taking these month-to-month variations into account may provide a more accurate budgeting of a funding pool than if a uniform monthly burn distribution of 8.33% was used. In addition to historical data, the user may adjust the monthly burn rate as desired. In one aspect, a default monthly burn rate may be a uniform 8.33%. In another aspect, a default monthly burn may be set to be equal to the monthly burn rate of the same month in the last recorded year (e.g., the burn rate for June 2009 may be set to be equal to the last recorded June month, for example, June 2008). The burn rate may be applied to the funding pool to generate the proportional budget for the time frame that the burn rate covers. That is, an actual dollar value of the funding pool which may be utilized (or burned) may be determined for that particular time frame.

At step 315, the module may retrieve actual funding levels for past months and may calculate a staffing level which may be supported by a specific funding pool given specified burn rates. The calculations that may be performed at step 315 are discussed further in detail herein.

At step 320, the module may display a model based on the retrieved, generated, or inputted data obtained in steps 305, 310 and 315. In one aspect, the data retrieved at steps 305, 310 and 315 are from a singular system of record. The singular system of record may be kept separate from each line of business or portfolio of which the data of the system of record covers. In another aspect, the system of record is an organizational tool servicing each of the different service providers and may be, for example, a central database.

In one aspect, the model is flexible in that a user may instead input a desired funding pool and a desired burn rate and, in response, the model may generate the maximum staffing levels supported by the specified funding pool. In another aspect, the model may retrieve the inputs from a database.

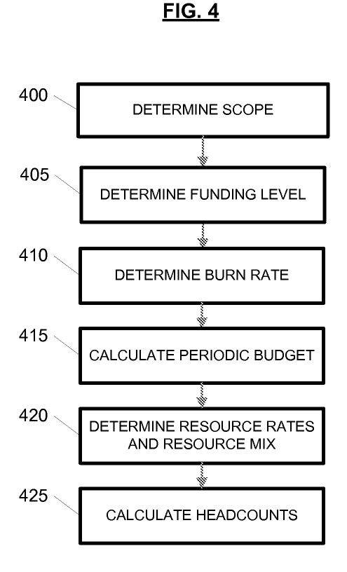

A method of calculating a future staffing level is illustrated in FIG. 4. At step 400, the scope of time that the user desires to model (e.g., from Jan. 1, 2009-Jan. 1, 2010) and the increment desired (monthly, quarterly, and the like) may be determined. At step 405, the funding level for the desired scope may be determined. Where the scope spans several years, same or different annual funding pool amounts for each the particular years may be determined. At step 410, the burn rates may be determined. Next, at step 415, based on the burn rate and funding level a periodic budget may be calculated. As the burn level represents the share of the entire pool that the particular month is allotted, by multiplying the funding level by the burn rate for the period (wherein the burn rates for the entire annum adds up to 100%), a corresponding budget for the increment desired may be obtained.

For a 12-month year, an evenly balanced monthly burn rate would be 8.33%. That is every month 8.33% of the annual budget or funding level may be used up or burned. It follows then that an annual funding level of $100,000 with a perfectly distributed monthly burn rate of 8.33% would yield a monthly budget of $8333.33 for staffing.

At step 420, the resource rates and resource mix may be ascertained. Based on the monthly budget and hourly values for each worker (which may be different for employees, contractors, and the like) the number of workers that may fit under the budget may be determined. For example, where employees work 40 hours a month and are given rates of 15 dollars an hour, 1 employee may account for $600 of the $8333.33 monthly budget. In another example, where general contractors work 20 hours a month and are given rates of 20 dollars an hour, the general contractors may account for $400 of the $8333.33 monthly budget. Here, additional factors such as a ratio or mix value of the different workers may be selected by the user. Such a factor may be used to narrow the set of possible solutions fitting the funding level, burn rate, and other set variables. In one aspect, the resource mix is a factor that is set equal to the existing mix of resources currently utilized by the business.

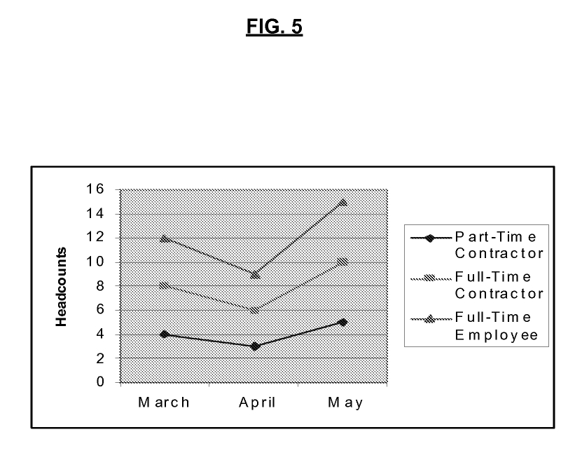

At step 425, the staffing level may be forecasted by breaking down the corresponding budget by ascertaining the solutions that satisfy the resource mix, the budget, and hourly rates of each worker. FIG. 5 illustrates an example of a model of a forecasted staffing level of various resource types according to one or more aspects described herein.

The model of FIG. 5 may span several selected portfolios which may share a portion of an entire funding pool for supporting an entire business. Furthermore, the time frame for this particular model covers March to May in monthly increments. The model may retrieve actual statistics for March and use those statistics and a projected budget increase to forecast staffing levels for April and May. For example, assume that the burn rate for March was 12.8%, the burn rate for April and May are projected to be 9.6% and 13.33% respectively, and the annual funding pool is set to increase from $100,000 in March to $120,000 in May. Based on the annual funding pool and monthly burn rate, the modeling tool may calculate a monthly budget by multiplying the budget and the burn rate for the particular months. Next, the tool may calculate the actual headcounts of the different resource types based on a resource mix. For example, FIG. 5 assumes that there are three resource types available for input—full-time employees, full-time contractors, and part-time contractors—and that their respective hourly values are $25/hour, $20/hour, and $10/hour. Moreover, assume that the full-time employees and contractors work 40 hours a month, whereas the part-time contractor works 10 hours a month. Given a resource mix of 1 full-time employee for every 2 full-time contractors, and 3 part-time contractors, the budget for March ($12,800) may support a total of 4 full-time employees, 8 full-time contractors, and 12 part-time employees. For April, assuming all other variables equal, a burn rate of 9.6% equates to a monthly budget of $9,600 which may support 3 full-time employees, 6 full-time contractors, and 9 part-time employees while satisfying the same resource mix as March. For May, based on a burn rate of 13.33% and a projected annual funding pool of $120,000, the monthly budget is approximately $16,000. Based on the same resource mix as March and April, the May budget may support 5 full-time employees, 10 full-time contractors, and 15 part-time employees.

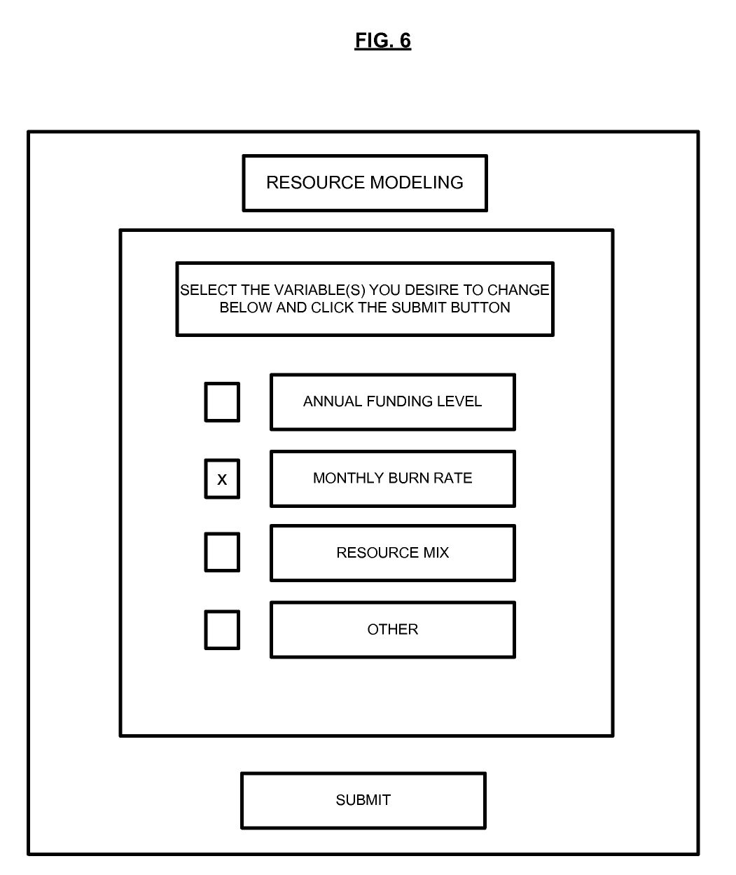

Based on FIG. 5, the business may determine that it would need to reduce 1 employee, 2 full-time contractors, and 3 part-time contractors for April, but would then need to add 2 full-time employees, 4 full-time contractors, and 6 part-time contractors for May. The business may decide that such a swing from month-to-month is not practical. The model may then allow the user to alter or lift the constraint (e.g., resource mix). For example, FIG. 6 illustrates an example of an interface that a user may use to change one of the variables used by the model.

In another aspect, the user may designate to keep the full-time employees at the same level (e.g., keep 4 full-time employees) for a period of time (e.g., April and May), and may further set a desired ratio of full-time contractors and part-time contractors. The user may desire to generate an updated model based on the new variables. For the sake of convenience, the example uses whole numbers for variables such as the resource mix, head counts, and the like. However, one of ordinary skill in the art will recognize that non-whole numbers such as fractions are possible as well. For example, one full-time employee may be staffed on portfolios A and B, and as such may count as “0.5 full-time employees” for portfolios A and B, respectively.

This example illustrates the relationship between some variables taken into the account by the model. This model may be adjusted as desired. For example, the model may be easily extrapolated to cover many lines of businesses and many portfolios. In another example, the model may take into account other variables such as preliminary deductions to the funding pool for reserves and the like. In another aspect, the model may calculate a funding level given burn rates and a desired resource level.

In another aspect, the user may request the model illustrate the maximum number of employees or the maximum number of a type of contractor based on the variables obtained. One benefit of the versatility of the modeling tool is that it allows a user to visually ascertain the impact of different variables over a large scale of data. For example, the user may first desire to view the number of resources possible based on a selected resource mix for a funding level limited to a small number of portfolios. Next, the user may decide to raise the funding level to see how many more workers and the types of workers that may be hired for the additional funding based on a set burn rate. Moreover, the user may choose a different burn rate to see how that would impact the number of workers available. In yet another aspect, the user may choose a different worker mix (e.g., ratio of employees to contractors) and see how the model further changes. Such a versatile resource modeling tool may allow the user to make informed decisions on strategic planning such as being able to accurately determine whether to maintain, add, or reduce resources based on any vantage point by taking in any changes in any of the variables and generating a new model such that a user may be able to visually see the impact of changing the variable by comparing the results of the different models.

One assumption that may be optionally applied to the model is that the actual staffing levels and corresponding actual funding levels are sufficient to support a portfolio or service provider. Such an assumption alleviates any concerns as to whether forecasted data is capable of supporting the portfolios and/or the service providers as the forecasted data is based in part or fully on actual staffing levels and actual funding levels. That is, when forecasting future data based on actual data, the future data may be considered to be trustworthy under the assumption that the actual funding pool and corresponding staffing levels were sufficient to support any of a number of projects or portfolios for that timeframe that the actual data is based on.

FIG. 3B is a flowchart illustrating a method of updating an existing model by changing one or more variables in accordance with one or more aspects described herein. In one aspect, step 325 follows step 320 of FIG. 3A. At step 325, the module receives a user request to change one or more variables. At step 330, new variables may be received, current variables may be replaced, and the like. That is, the user may customize the model to use some but not all of the previous statistics used to generate the previous model. For example, the user may increase the forecasted annual funding pool. Accordingly, with a higher pool, more workers may be hired and may be modeled by the module. At step 335, the module may re-calculate the mix of employees, contractors, etc. based on the increased pool. At step 340, the module may create a visual display of the updated model such that a user may be able to visually compare a model without the changed variable and the model with the changed variable.

In one aspect, all statistics and assumptions from a set of actual data (e.g., actual budget, staffing levels, burn rates, resource mix, etc. of the last month for which data is available), the module may generate a new model for the following months in response to one of the variables being adjusted.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. Examples of computer readable media that may be used include RAM, ROM, EEPROM, flash memory or other memory technology, CD-ROM, DVD or other optical disk storage, magnetic cassettes, magnetic tape, magnetic storage and the like. In addition, various signals representing data or events as described herein may be transferred between a source and a destination in the form of electromagnetic waves traveling through signal-conducting media such as metal wires, optical fibers, and/or wireless transmission media (e.g., air and/or space).

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A computer-implemented method comprising:
receiving a request to generate a first graphical model for modeling human resources based on at least a funding pool and a number of each human resource type supportable by the funding pool;
receiving information defining a scope of the first graphical model, wherein the scope includes a time-frame for which the first graphical model is to span and a desired interval of modeling within the time-frame;
receiving data corresponding to one or more variables associated with the first graphical model;
determining a variable in the first graphical model not having a value, the variable being one of: a funding pool corresponding to the time-frame of which the first graphical model spans, and a number for each human resource type within the scope supportable by the funding pool;
calculating the value for the determined variable, wherein the calculated value is based on at least one of: a predetermined equation and a default value; and
generating the first graphical model based on the variable values.

2. The computer-implemented method of claim 1, further comprising:
receiving a request to generate a second graphical model for modeling human resources, wherein the second graphical model differs from the first graphical model in at least one variable value;
assuming that all variable values are the same from the first graphical model;
receiving an input value for at least one variable, wherein each received input value differs from the value of a corresponding variable of the first graphical model;
determining whether the changed input value affects other variables of the second graphical model based on pre-determined rules;
in response to determining that the input value affects other variables of the second model, calculating an updated value for one or more affected variables; and
generating a second graphical model related to human resources based on each of the inputs and variable values.

3. The computer-implemented method of claim 1, wherein the scope further includes an input of one of: one or more portfolios of projects and one or more service providers, wherein each portfolio is configured to correspond to one or more service providers, and wherein each service provider is configured to correspond to one or more portfolios.

4. The computer-implemented method of claim 1, wherein the determined variable is the number for each human resource type, wherein calculating the number for each human resource type for each interval comprises:
calculating a the portion of the funding pool allocated to each interval of modeling based on a burn rate corresponding to the particular interval of modeling by multiplying the burn rate for each interval by the entire funding pool;
calculating a resource type interval value for each resource type by multiplying a resource type hourly value by the number of hours worked by the resource type during the interval;
calculating a resource mix interval value based on a resource mix, wherein the resource mix represents a ratio of each resource type to each other resource type and includes a resource mix ratio value for each resource type, wherein the resource mix interval value is obtained by adding together each result of multiplying the resource mix value for each resource type by the corresponding resource type interval value; and
calculating a resource mix factor by dividing the funding pool allocated to the particular interval by the resource mix interval value, wherein the number of each human resource type for a particular interval is equal to the resource factor of the resource type multiplied by the corresponding resource mix ratio value for the particular resource type.

5. The computer-implemented method of claim 1, wherein the determined variable is the funding pool, wherein the funding pool is equal to the sum of each funding sub-pool corresponding to each interval of the model, wherein calculating the funding sub-pool for each interval comprises:
determine a total number of each resource type desired for the interval;
calculating the product of the number of each resource type, a corresponding resource type hourly value, and the number of hours worked by each resource of the resource type during the interval; and
calculating the sum of the products.

6. The computer-implemented method of claim 4, wherein the human resource types include at least one employee and one contractor, and wherein the resource mix includes a ratio of a number of employees and a number of contractors.

7. The computer implemented method of claim 1, wherein the calculated one or more values is a forecasted value, with the forecasted value based upon a historical value.

8. An apparatus comprising:
a processor; and,
a memory operatively coupled to the processor and storing computer-readable instructions, that when executed, cause the apparatus to:
receive a request to generate a first graphical model for modeling human resources based on at least a funding pool and a number of each human resource type supportable by the funding pool;
receive information defining a scope of the first graphical model, wherein the scope includes a time-frame for which the first graphical model is to span and a desired interval of modeling within the time-frame;
receive data corresponding to one or more variables associated with the first graphical model;
determine a variable in the first graphical model not having a value, the variable being one of: a funding pool corresponding to the time-frame of which the first graphical model spans, and a number for each human resource type within the scope supportable by the funding pool;
calculate the value for the determined variable, wherein the calculated value is based on at least one of: a predetermined equation and a default value; and
generate the first graphical model based on the variable values.

9. The apparatus of claim 8, the memory further storing computer-readable instructions, that when executed, cause the apparatus to:
receive a request to generate a second graphical model for modeling human resources, wherein the second graphical model differs from the first graphical model in at least one variable value;
assume that all variable values are the same from the first graphical model;
receive an input value for at least one variable, wherein each received input value differs from the input value of a corresponding variable of the first graphical model;
determine whether the changed input value affects other variables of the second graphical model based on pre-determined rules;
calculate an updated value for one or more affected variables in response to determining that the value affects other variables of the second model; and
generate a second graphical model related to human resources based on each of the inputs and variable values.

10. The apparatus of claim 8, wherein the scope further includes an input of one of: one or more portfolios of projects and one or more service providers, wherein each portfolio is configured to correspond to one or more service providers, and wherein each service provider is configured to correspond to one or more portfolios.

11. The apparatus of claim 8, wherein the determined variable is the number for each human resource type, wherein calculating the number for each human resource type for each interval comprises:
calculating a the portion of the funding pool allocated to each interval of modeling based on a burn rate corresponding to the particular interval of modeling by multiplying the burn rate for each interval by the entire funding pool;
calculating a resource type interval value for each resource type by multiplying a resource type hourly value by the number of hours worked by the resource type during the interval;
calculating a resource mix interval value based on a resource mix, wherein the resource mix represents a ratio of each resource type to each other resource type and includes a resource mix ratio value for each resource type, wherein the resource mix interval value is obtained by adding together each result of multiplying the resource mix value for each resource type by the corresponding resource type interval value; and
calculating a resource mix factor by dividing the funding pool allocated to the particular interval by the resource mix interval value, wherein the number of each human resource type for a particular interval is equal to the resource factor of the resource type multiplied by the corresponding resource mix ratio value for the particular resource type.

12. The apparatus of claim 8, wherein the determined variable is the funding pool, wherein the funding pool is equal to the sum of each funding sub-pool corresponding to each interval of the model, wherein calculating the funding sub-pool for each interval comprises:
determine a total number of each resource type desired for the interval;
calculating the product of the number of each resource type, a corresponding resource type hourly value, and the number of hours worked by each resource of the resource type during the interval; and
calculating the sum of the products.

13. The apparatus of claim 10, wherein the human resource types include at least one employee and one contractor, and wherein the resource mix includes a ratio of a number of employees and a number of contractors.

14. The apparatus of claim 8, wherein the calculated one or more values is a forecasted value, with the forecasted value based upon a historical value.

15. One or more computer-readable media storing instructions that when executed by a processor perform a method comprising:
receiving a request to generate a first graphical model for modeling human resources based on at least a funding pool and a number of each human resource type supportable by the funding pool;
receiving information defining a scope of the first graphical model, wherein the scope includes a time-frame for which the first graphical model is to span and a desired interval of modeling within the time-frame;
receiving data corresponding to one or more variables associated with the first graphical model;
determining a variable in the first graphical model not having a value, the variable being one of: a funding pool corresponding to the time-frame of which the first graphical model spans, and a number for each human resource type within the scope supportable by the funding pool;
calculating the value for the determined variable, wherein the calculated value is based on at least one of: a predetermined equation and a default value; and
generating the first graphical model based on the variable values.

16. The one or more computer readable media of claim 15, storing instructions that when executed, further perform:
receiving a request to generate a second graphical model for modeling human resources, wherein the second graphical model differs from the first graphical model in at least one variable value;
assuming that all variable values are the same from the first graphical model;
receiving an input value for at least one variable, wherein each received input value differs from the value of a corresponding variable of the first graphical model;
determining whether the changed input value affects other variables of the second graphical model based on pre-determined rules;
in response to determining that the input value affects other variables of the second model, calculating an updated value for one or more affected variables; and
generating a second graphical model related to human resources based on each of the inputs and variable values.

17. The one or more computer readable media of claim 15, wherein the scope further includes an input of one of: one or more portfolios of projects and one or more service providers, wherein each portfolio is configured to correspond to one or more service providers, and wherein each service provider is configured to correspond to one or more portfolios.

18. The one or more computer readable media of claim 15, wherein the determined variable is the number for each human resource type, wherein calculating the number for each human resource type for each interval comprises:
calculating a the portion of the funding pool allocated to each interval of modeling based on a burn rate corresponding to the particular interval of modeling by multiplying the burn rate for each interval by the entire funding pool;
calculating a resource type interval value for each resource type by multiplying a resource type hourly value by the number of hours worked by the resource type during the interval;
calculating a resource mix interval value based on a resource mix, wherein the resource mix represents a ratio of each resource type to each other resource type and includes a resource mix ratio value for each resource type, wherein the resource mix interval value is obtained by adding together each result of multiplying the resource mix value for each resource type by the corresponding resource type interval value; and
calculating a resource mix factor by dividing the funding pool allocated to the particular interval by the resource mix interval value, wherein the number of each human resource type for a particular interval is equal to the resource factor of the resource type multiplied by the corresponding resource mix ratio value for the particular resource type.

19. The one or more computer readable media of claim 15, wherein the determined variable is the funding pool, wherein the funding pool is equal to the sum of each funding sub-pool corresponding to each interval of the model, wherein calculating the funding sub-pool for each interval comprises:
determining a total number of each resource type desired for the interval;
calculating the product of the number of each resource type, a corresponding resource type hourly value, and the number of hours worked by each resource of the resource type during the interval; and
calculating the sum of the products.

20. The one or more computer readable media of claim 18, wherein the human resource types include at least one employee and one contractor, and wherein the resource mix includes a ratio of a number of employees and a number of contractors.

21. The one or more computer readable media of claim 15, wherein the calculated one or more values is a forecasted value with the forecasted value based upon a historical value.
